(19) United States
(12) Patent Application Publication
(10) Pub. No.: US 2020/0031590 A1
(43) Pub. Date: Jan. 30, 2020

(54) DEVICE AND METHOD FOR DETECTING BREAKAGE OF SUBSTRATE AND SUBSTRATE TRANSFER SYSTEM

(71) Applicants: HEFEI XINSHENG OPTOELECTRONICS TECHNOLOGY CO., LTD., Hefei (CN); BOE TECHNOLOGY GROUP CO., LTD., Beijing (CN)

(72) Inventors: Minglong LI, Beijing (CN); Zhiqiang WANG, Beijing (CN); Ronglong CHEN, Beijing (CN); Jiyan MA, Beijing (CN); Pengfei YIN, Beijing (CN); Hongfei GAO, Beijing (CN)

(21) Appl. No.: 16/334,450

(22) PCT Filed: May 17, 2018
(86) PCT No.: PCT/CN2018/087250

§ 371 Date: Mar. 19, 2019

(30) Foreign Application Priority Data
May 22, 2017 (CN) 201710364818.5

(51) Int. Cl. B65G 43/08; B65G 49/06; G01N 27/24

(52) U.S. Cl. CPC B65G 43/08; B65G 2203/04; G01N 27/24; B65G 49/063

(57) ABSTRACT

Embodiments of the present disclosure provide a device and a method for detecting breakage of a substrate and a substrate transfer system. The device includes a first electrode and a second electrode arranged oppositely, a power source, and a detector. The power source may provide an alternating current voltage to the first electrode and the second electrode. The detector is arranged between the power source and the first electrode or the second electrode and may detect, when the substrate is placed between the first electrode and the second electrode, a current value in the substrate, and determine whether the substrate is damaged based on the detected current value.

### CROSS REFERENCE TO RELATED APPLICATIONS

This patent application is a National Stage Entry of PCT/CN2018/087250 filed on May 17, 2018, which claims the benefit and priority of Chinese Patent Application No. 201710364818.5 filed on May 22, 2017, the disclosures of which are incorporated by reference herein in their entirety as part of the present application.

### BACKGROUND

Embodiments of the present disclosure relate to the field of liquid crystal display technologies, and more particularly, to a device and a method for detecting breakage of a substrate, and a substrate transfer system.

Liquid crystal display devices are more and more widely used in life. At present, in the manufacture of liquid crystal display and touch devices, transparent glass having a material thickness of 0.4-1.1 mm is generally employed as a substrate of a liquid crystal display device. Due to its thin and fragile characteristics, the substrate is liable to fracture in a transfer process. A damaged substrate may seriously damage a transfer device, and may also have a great risk of damage to a coating device and an exposure device. Therefore, detection of the damaged substrate is particularly important.

### BRIEF DESCRIPTION

Embodiments of the present disclosure provide a device and a method for detecting breakage of a substrate and a substrate transfer system.

A first aspect of the present disclosure provides a device for detecting breakage of a substrate. The device includes a first electrode and a second electrode arranged oppositely, a power source, and a detector. The power source may provide an alternating current voltage to the first electrode and the second electrode. The detector is arranged between the power source and the first electrode or the second electrode and may detect, when the substrate is placed between the first electrode and the second electrode, a current value in the substrate, and determine whether the substrate is damaged based on the detected current value.

In some embodiments of the present disclosure, the first electrode contacts a surface of the substrate, and the second electrode contacts another surface of the substrate.

In some embodiments of the present disclosure, the first electrode is arranged in parallel with the second electrode, and a distance between the first electrode and the second electrode is greater than a thickness of the substrate.

In some embodiments of the present disclosure, the distance is 2 mm-6 mm greater than the thickness of the substrate.

In some embodiments of the present disclosure, the first electrode and the second electrode have a same size which is determined by a width or a length of the substrate.

In some embodiments of the present disclosure, the first electrode and the second electrode are planar continuous electrodes.

In some embodiments of the present disclosure, the detector may further compare the detected current value with a current threshold range. The detector determines that the substrate is damaged if the detected current value is outside the current threshold range. The detector determines that the substrate is not damaged if the detected current value is within the current threshold range.

In some embodiments of the present disclosure, the detector may further calculate a difference between the detected current value and a normal current value of an undamaged substrate which is the same as the substrate. The detector determines that the substrate is damaged if the difference exceeds a threshold. The detector determines that the substrate is not damaged if the difference does not exceed the threshold.

A second aspect of the present disclosure also provides a substrate transfer system. The system includes the device for detecting breakage of a substrate according to the first aspect of the present disclosure and a device for transferring a substrate. The device for transferring the substrate is electrically coupled to the detector and may transfer the substrate between the first electrode and the second electrode and stop transferring the substrate based on an instruction indicating that the substrate is damaged from the detector.

A third aspect of the present disclosure also provides a method for detecting breakage of a substrate. In this method, an alternating current voltage is applied to a first electrode arranged above the substrate and a second electrode arranged below the substrate. Next, it is detected a current value of an electric current in the substrate, and it is determined whether the substrate is damaged based on the detected current value.

In some embodiments of the present disclosure, the determining whether the substrate is damaged based on the detected current value includes comparing the detected current value with a current threshold range, determining that the substrate is damaged if the detected current value is outside the current threshold range, and determining that the substrate is not damaged if the detected current value is within the current threshold range.

In some embodiments of the present disclosure, the determining whether the substrate is damaged based on the detected current value includes calculating a difference between the detected current value and a normal current value of an undamaged substrate which is the same as the substrate, determining that the substrate is damaged if the difference exceeds a threshold, and determining that the substrate is not damaged if the difference does not exceed the threshold.

In some embodiments of the present disclosure, the method further includes transferring the substrate between the first electrode and the second electrode.

In some embodiments of the present disclosure, the method further includes stopping transferring the substrate after determining that the substrate is damaged.

### BRIEF DESCRIPTION OF THE DRAWINGS

To describe the technical solutions of the present disclosure more clearly, the accompanying drawings of the embodiments will be briefly introduced below, and the same or similar numeral represents the same or similar elements or elements having the same or similar functions. It is to be known that the accompanying drawings in the following description merely involve with some embodiments of the present disclosure, but not limit the present disclosure. In the drawings:

FIG. 1 illustrates a schematic structural diagram of a device for detecting breakage of a substrate according to an embodiment of the present disclosure;

FIG. 2 illustrates a schematic diagram of performing a non-contact detection by a device for detecting breakage of a substrate according to an embodiment of the present disclosure;

FIG. 3 illustrates a curve chart of a relative dielectric constant of a glass substrate;

FIG. 4 illustrates a schematic diagram of performing a contact detection by a device for detecting breakage of a substrate according to an embodiment of the present disclosure;

FIG. 5 illustrates a schematic structural diagram of a substrate transfer system according to an embodiment of the present disclosure; and

FIG. 6 illustrates a schematic flowchart of a method for detecting breakage of a substrate according to an embodiment of the present disclosure.

### DETAILED DESCRIPTION

To make the technical solutions and advantages of the embodiments of the present disclosure clearer, the technical solutions in the embodiments of the present disclosure will be described clearly and completely below, in conjunction with the accompanying drawings. Apparently, the described embodiments are merely some but not all of the embodiments of the present disclosure. All other embodiments obtained by those of ordinary skill in the art based on the described embodiments without creative efforts shall fall within the protection scope of the present disclosure.

A person skilled in the art may understand that the singular forms “a”, “an”, “said” and “the” used herein may also include plural forms, unless otherwise specifically stated. The term “and/or” used herein includes any one unit and all combinations of one or more associated listed items.

It is to be noted that expressions using “first” and “second” in embodiments of the present disclosure are merely intended to distinguish two different entities or different parameters having the same names. Thus, “first” and “second” are merely for ease of expression, but should not be interpreted as limitations to the embodiments of the present disclosure, which is not described one by one in the following embodiments.

In the description of the embodiments of the present disclosure, it is to be noted that unless explicitly specified or limited otherwise, terms “installation”, “connecting” or “coupling” should be understood in a broad sense, which may be, for example, a fixed connection, a detachable connection or integrated connection, a mechanical connection or an electrical connection, a direct connection or indirect connection by means of an intermediary. For those of ordinary skill in the art, specific meanings of the above terms in the present disclosure may be understood based on specific circumstances.

At present, the technology for detection of a damaged substrate mainly includes an image analysis and detection technology and an optical fiber sensor detection technology.

For the image analysis and detection technology, image scanning is performed on a substrate in the process of substrate transfer, and then the obtained image is analyzed to determine whether an edge of the substrate has defects. This detection technology has a limited detection range and can only detect the edge portion of the substrate, but cannot perform a comprehensive detection on the substrate. In addition, a false detection is likely to occur when the surface of the substrate is stained. That is, such detection technology is susceptible to cleanliness of the substrate and thus may cause a false detection or missing detection.

For the optical fiber sensor detection technology, a reflective optical fiber sensor is mounted on each side of a device. When the substrate passes, substrate conditions may be detected on two straight lines based on intensity of the light received by a receiving terminal. This detection means is also susceptible to cleanliness of the substrate and thus may cause a false detection or missing detection. Furthermore, this detection means is also susceptible to cleanliness of the sensor and thus may cause a false detection or missing detection.

Therefore, the two detection methods above are susceptible to cleanliness of the substrate or the sensor and thus may cause a false detection or missing detection. In addition, the detection range is only limited to the edge of the substrate, and it is impossible to detect the overall damage condition of the substrate.

The device for detecting breakage of a substrate (hereinafter to be referred as a substrate detection device) and a method for detecting breakage of a substrate and a substrate transfer system provided by embodiments of the present disclosure are provided for detecting the overall damage condition of a substrate, and may avoid cleanliness of the substrate or the sensor having a negative effect on a detection result. Therefore, the accuracy of the detection result can be improved.

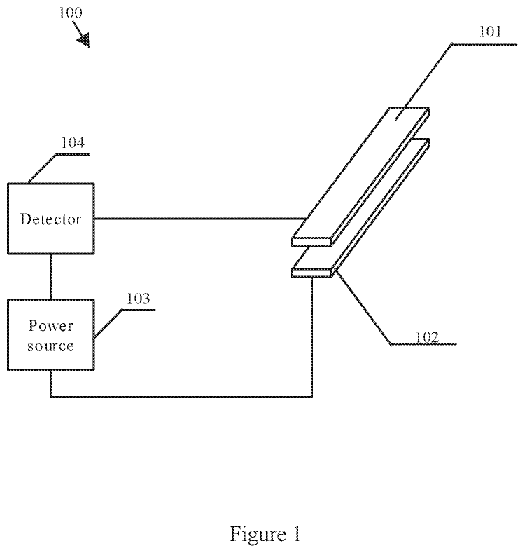

FIG. 1 illustrates a schematic structural diagram of a device for detecting breakage of substrate (referred as to a substrate detecting device) 100 according to an embodiment of the present disclosure. As shown in FIG. 1, the substrate detecting device 100 may include a first electrode 101 and a second electrode 102 arranged oppositely, a power source 103, and a detector 104.

In some embodiments of the present disclosure, the first electrode 101 and the second electrode 102 may be planar continuous electrodes such as plate-shaped electrodes. Furthermore, the first electrode 101 and the second electrode 102 may have a same size which is determined by a width or a length of the substrate. When the substrate detecting device 100 is used, a to-be-detected substrate may be placed between the first electrode 101 and the second electrode 102. For example, the first electrode 101 may be placed above the to-be-detected substrate, and the second electrode 102 may be placed below the to-be-detected substrate.

The power source 103 may be coupled to the first electrode 101 and the second electrode 102 and is configured to provide an alternating current (AC) voltage to the first electrode 101 and the second electrode 102. In some embodiments, the provided AC voltage is a high-frequency voltage, the frequency range of which may range, for example, from 1 kHz to 1 MHz.

The detector 104 may be arranged between the power source 103 and any electrode (the first electrode 101 or the second electrode 102). The detector 104 may detect, when the substrate is placed between the first electrode 101 and the second electrode 102, a current value in the substrate, and determine whether the substrate is damaged based on the detected current value. As shown in FIG. 1, the detector 104 may be arranged, for example, between the power source 103 and the first electrode 101. As a poor conductor of electricity, the substrate has capacitance characteristics, allowing alternating current to pass. Therefore, a current path can be formed among the first electrode 101, the detector 104, the power source 103, the second electrode 102, and the substrate serving as a capacitance load.

If the substrate is damaged, the dielectric constant of the substrate may be changed, and thus the impedance to the alternating current voltage also may be changed, which may cause the alternating current in the substrate to be changed. Based on variation of current in the current path where the substrate is detected, it may be determined whether the substrate is damaged under the AC voltage. The dielectric constant of any damaged portion on the surface of the substrate may be changed. Therefore, the application of the AC voltage may be suitable for detection of a damaged portion on the surface of the whole substrate, such that it is no longer limited to the detection of the edge of the substrate. In addition, a stain on the substrate has little effect on the dielectric constant of the substrate. Therefore, under the control of the AC voltage, the alternating current changes little due to the stain on the substrate. Therefore, the negative effect of the cleanliness of the substrate on the detection result may be avoided, thereby improving the accuracy of the detection result.

In some embodiments of the present disclosure, the detector 104 may compare the detected current value with a current threshold range. The detector 104 may determine that the substrate is damaged if the detected current value is outside the current threshold range. The detector 104 may determine that the substrate is not damaged if the detected current value is within the current threshold range.

In another embodiment, the detector 104 may detect, in advance, a normal current value of an undamaged substrate which is the same as the to-be-detected substrate. For example, the undamaged substrate and the to-be-detected substrate are made from the same material or have an equal thickness. Then, the detector 104 may calculate a difference between the detected current value of the to-be-detected substrate and the normal current value of the undamaged substrate. The detector 104 may determine that the substrate is damaged if the difference exceeds a first threshold. The detector 104 may determine that the substrate is not damaged if the difference is not exceed the first threshold.

Furthermore, the detector 104 may continuously detect the current value in the substrate during a time period when the substrate is transferred through between the first electrode 101 and the second electrode 102. The substrate is determined to be damaged if an amplitude variation of the detected current exceeds a second threshold within the substrate transfer period. The substrate is determined to be not damaged if the variation amplitude of the current does not exceed the second threshold.

Those skilled in the art may understand that the above current threshold range, the first threshold, and the second threshold may be set empirically.

In some embodiments of the present disclosure, the power source 103 and the detector 104 may be implemented in a programmable logic controller (PLC controller) to simplify a circuit connection structure.

In some embodiments of the present disclosure, when detecting by using the substrate detecting device 100, the first electrode and the second electrode may contact or not contact a surface of the substrate therebetween. That is, a gap may exist or not exist between the two electrodes and the surface of the substrate. The detection mode based on a contact between the electrodes and the surface of the substrate may be suitable for detection of a substrate in a static condition, whereas the detection mode based on a gap between the electrodes and the surface of the substrate may be employed in a process of transferring the substrate. The two detection modes are respectively described below.

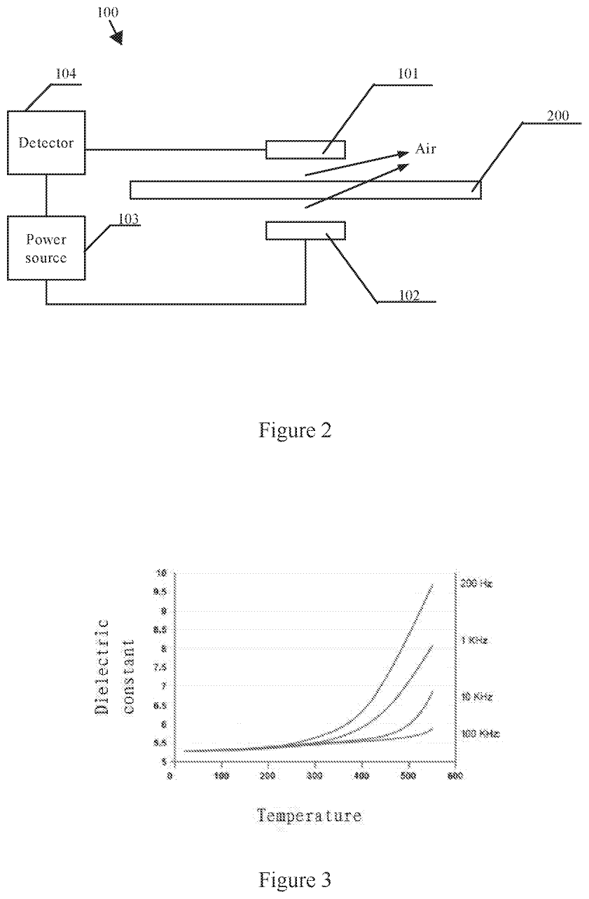

FIG. 2 illustrates a schematic diagram of performing a non-contact detection by the substrate detecting device 100 according to an embodiment of the present disclosure. As shown in FIG. 2, the first electrode 101 and the second electrode 102 in the substrate detecting device 100 are arranged in parallel, and a distance between the first electrode 101 and the second electrode 102 is greater than a thickness of the substrate 200. Therefore, when the substrate 200 is placed between the first electrode 101 and the second electrode 102, neither the first electrode 101 nor the second electrode 102 may contact an upper surface and a lower surface of the substrate 200. Air may exist between the first electrode 101 and the upper surface of the substrate 200, and air may also exist between the second electrode 102 and the lower surface of the substrate 200.

The substrate 200 between the first electrode 101 and the second electrode 102 and the air constitute a flat capacitor. In the case that an edge effect is ignored, a capacitance of the flat capacitor may be calculated as below:

$$C = \frac{{ɛɛ}_{0} s}{d}$$

wherein C represents the capacitance of the flat capacitor, E represents a relative dielectric constant of the substrate, ε0 represents a vacuum dielectric constant, S represents an area of the flat capacitor, and d represents a thickness of the substrate.

FIG. 3 illustrates a curve chart of a relative dielectric constant of a glass substrate. For example, in the case that the temperature ranges from about 50° C. to 300° C. and the frequency ranges from about 100 KHz to 200 KHz, the relative dielectric constant of the glass substrate approximately is about 5.4-5.6. The relative dielectric constant of the air is different from that of the substrate, and the relative dielectric constant of the air is 1. The thickness d of the substrate may change if the substrate is damaged, thus the capacitance of the flat capacitor may be changed, such that the alternating current impedance may be changed. Correspondingly, when an alternating current voltage is provided to the first electrode 101 and the second electrode 102, it can determine whether the substrate is in good condition by measuring the variation of current in a circuit.

In some embodiments of the present disclosure, the distance between the first electrode 101 and the second electrode 102 is about 2 mm-6 mm greater than the thickness of the substrate. For a higher detection sensitivity, the difference between the distance and the thickness can be set as less than 6 mm. For not affecting the movement of the substrate between the two electrodes, the difference between the distance and the thickness of the substrate can be set as greater than 2 mm. For example, the to-be-detected substrate may be placed at a middle position between the two electrodes. The distance between the upper surface of the substrate and the first electrode 101 is greater than 1 mm and less than 3 mm, and the distance between the lower surface of the substrate and the second electrode 102 is greater than 1 mm and less than 3 mm.

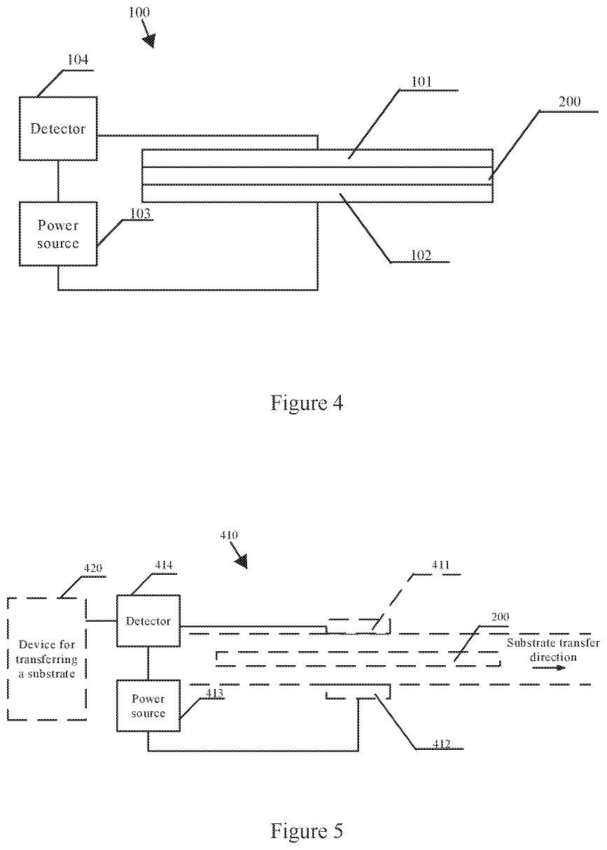

FIG. 4 illustrates a schematic diagram of performing a contact detection by the substrate detecting device 100 according to an embodiment of the present disclosure. As shown in FIG. 4, the first electrode 101 in the substrate detecting device 100 contacts the upper surface of the to-be-detected substrate 200, and the second electrode 102 contacts the lower surface of the substrate 200. Higher detection sensitivity may be achieved because the electrodes come into direct contact with the surfaces of the substrate 200 and there is no air between the electrodes and the substrate 200. However, since the electrodes contact the surface of the substrate 200, the substrate 200 may not be allowed to move during the detection. Instead, the substrate 200 may be in a static state, to prevent the electrode from scratching the surface of the substrate.

In the embodiment as shown in FIG. 4, the first electrode 101 and the second electrode 102 have the same size which is equal to the size of the to-be-detected substrate 200.

Further, the substrate detecting device provided by the embodiments of the present disclosure also may be used in a substrate transfer system, such that a scanning detection can be performed on the whole plane surface of the substrate in the process of transferring the substrate. FIG. 5 illustrates a schematic diagram of a substrate transfer system according to an embodiment of the present disclosure. The substrate transfer system includes a substrate detecting device 410 and a device for transferring a substrate (hereinafter referred to as a substrate transfer device) 420.

The substrate detecting device 410 may include a first electrode 411, a second electrode 412, a power source 413, and a detector 414. The substrate detecting device 410 may be, for example, the substrate detecting device 100 as shown in FIG. 1, and may perform a non-contact detection on the substrate as shown in FIG. 2. In this embodiment, the power source 413 may provide an alternating current voltage to the first electrode 411 and the second electrode 412. The detector 414 is arranged between the power source 413 and the first electrode 411 or the second electrode 412, and may detect, when the to-be-detected substrate 200 is placed between the first electrode 411 and the second electrode 412, a current value in the substrate 200. Furthermore, the detector 414 may determine whether the substrate 200 is damaged based on the detected current value, and provide, to the substrate transfer device 420, an instruction indicating whether the substrate 200 is damaged.

The substrate transfer device 420 may transfer the substrate 200 between the first electrode 411 and the second electrode 412. Moreover, the substrate transfer device 420 may be electrically coupled to the detector 414, and may stop transferring the substrate 200 based on an instruction indicating that the substrate 200 is damaged from the detector 414.

In some embodiments of the present disclosure, the detector 414 may compare the detected current value with a current threshold range. The detector 414 may determine that the substrate is damaged if the detected current value is outside the current threshold range, and may send, to the substrate transfer device 420, the instruction indicating that the substrate 200 is damaged. In such a case, the substrate transfer device 420 stops transferring the substrate 200 in response to the instruction from the detector 414. Moreover, the detector 414 may determine that the substrate 200 is not damaged if the detected current value is within the current threshold range.

In some embodiments of the present disclosure, the detector 414 may further calculate a difference between the detected current value and a normal current value of an undamaged substrate which is the same as the substrate. The detector 414 determines that the substrate is damaged if the difference exceeds a threshold, and sends, to the substrate transfer device 420, the instruction indicating that the substrate 200 is damaged. In such a case, the substrate transfer device 420 stops transferring the substrate 200 in response to the instruction from the detector 414. Moreover, the detector determines that the substrate 200 is not damaged if the difference does not exceed the threshold.

As can be seen above, by arranging the substrate detecting device in the substrate transfer system, a breakage of a substrate may be detected during transmission of the substrate. In this way, it may be timely detected whether the substrate being transferred is damaged, thereby preventing the damaged substrate from damaging to the transfer device or devices in subsequent processes (for example, exposure devices or coating devices).

In an embodiment of the substrate transfer system, the to-be-detected substrate needs to be transferred through a space between the first electrode 411 and the second electrode 412. Therefore, the distance between the first electrode 411 and the second electrode 412 should be greater than the thickness of the substrate, such that a gap exists between the surface of the substrate and the two electrodes. Further, the difference between the thickness of the substrate and the distance between the first electrode 101 and the second electrode 102 may be greater than 2 mm and less than 6 mm, such that the detection sensitivity can be increased and scratches on the electrodes due to uneven or warping surface of the substrate can be prevented in the substrate transfer process.

In this embodiment, the size of the first electrode is equal to the size of the second electrode, wherein the size can be determined by the width or length of the substrate. Specifically, the length of the electrode is equal to the length of the substrate perpendicular to a transfer direction. In this way, detection of the whole plane surface of the substrate may be achieved in the process of transferring the substrate through the space between the two electrodes. Thus, the damaged substrate can be intercepted in time. The damaged substrate can be prevented from causing serious damage to the transfer device or devices in subsequent processes, thereby reducing losses and increasing production efficiency.

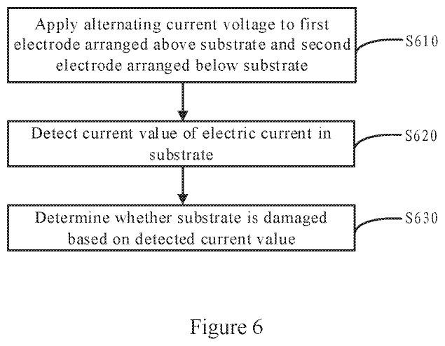

FIG. 6 illustrates a schematic flowchart of a method for detecting breakage of a substrate according to an embodiment of the present disclosure. First, in S610, an alternating current voltage is applied to a first electrode arranged above the substrate and a second electrode arranged below the substrate. In S620, a current value of an electric current is detected in the substrate. In S630, it is determined whether the substrate is damaged based on the detected current value.

In an embodiment, the determining whether the substrate is damaged based on the detected current value may include comparing the detected current value with a current threshold range, determining that the substrate is damaged if the detected current value is outside the current threshold range, and determining that the substrate is not damaged if the detected current value is within the current threshold range.

In another embodiment, the determining whether the substrate is damaged based on the detected current value may include calculating a difference between the detected current value and a normal current value of an undamaged substrate which is the same as the substrate, determining that the substrate is damaged if the difference exceeds a threshold, and determining that the substrate is not damaged if the difference does not exceed the threshold.

Further, the substrate may be transferred between the first electrode and the second electrode. Moreover, transferring the substrate may be stopped after determining that the substrate is damaged.

A person skilled in the art may understand that the steps, measures, and solutions in various operations, methods, and flows which have been discussed in the present disclosure may be alternated, changed, combined, or deleted. Further, other steps, measures, and solutions in various operations, methods, and flows which have been discussed in the present disclosure may also be alternated, changed, rearranged, decomposed, combined, or deleted. Further, the steps, measures, and solutions in various operations, methods, and flows disclosed in the present disclosure in the prior art may also be alternated, changed, rearranged, decomposed, combined, or deleted.

Those ordinary skilled in the art can understand, the discussion on any of the above embodiments is merely exemplary, without intention to imply that the scope of the present disclosure (including the claims) is limited to those embodiments, consistent with the thought of the present disclosure, combinations of the technical features in the above embodiments or different embodiments are feasible, steps may be implemented in any order, and many other changes in different aspects of the present disclosure may exist, for conciseness, these combinations and changes are not presented in details. Therefore, any omission, modification, equivalent replacement, improvements among others within the spirit and principle of the present disclosure should be contained within the protection scope of the present disclosure.

1. A device for detecting breakage of a substrate, the device comprising:
a first electrode and a second electrode arranged oppositely;
a power source configured to provide an alternating current voltage to the first electrode and the second electrode; and
a detector arranged between the power source and the first electrode or the second electrode and configured to detect, when the substrate is placed between the first electrode and the second electrode, a current value in the substrate, and determine whether the substrate is damaged based on the detected current value.

2. The device according to claim 1, wherein the first electrode contacts a surface of the substrate, and wherein the second electrode contacts another surface of the substrate.

3. The device according to claim 1, wherein the first electrode is arranged in parallel with the second electrode, and wherein a distance between the first electrode and the second electrode is greater than a thickness of the substrate.

4. The device according to claim 3, wherein the distance is about 2 mm-6 mm greater than the thickness of the substrate.

5. The device according to claim 1, wherein the first electrode and the second electrode have a same size which is determined by one of a width and a length of the substrate.

6. The device according to claim 1, wherein the first electrode and the second electrode are planar continuous electrodes.

7. The device according to claim 1, wherein the detector is further configured to:
compare the detected current value with a current threshold range;
determine that the substrate is damaged when the detected current value is outside the current threshold range; and
determine that the substrate is not damaged when the detected current value is within the current threshold range.

8. The device according to claim 1, wherein the detector is further configured to:
calculate a difference between the detected current value and a normal current value of an undamaged substrate which is the same as the substrate;
determine that the substrate is damaged when the difference exceeds a threshold; and
determine that the substrate is not damaged when the difference does not exceed the threshold.

9. A substrate transfer system comprising:
a device for detecting breakage of a substrate according to claim 1; and
a device for transferring a substrate, which is electrically coupled to the detector and configured to transfer the substrate between the first electrode and the second electrode and stop transferring the substrate based on an instruction from the detector indicating that the substrate is damaged.

10. The system according to claim 9, wherein the first electrode and the second electrode are planar continuous electrodes.

11. The system according to claim 9, wherein the detector is further configured to:
compare the detected current value with a current threshold range;
determine that the substrate is damaged when the detected current value is outside the current threshold range; and
determine that the substrate is not damaged when the detected current value is within the current threshold range.

12. The system according to claim 9, wherein the detector is further configured to:
calculate a difference between the detected current value and a normal current value of an undamaged substrate which is the same as the substrate;
determine that the substrate is damaged when the difference exceeds a threshold; and
determine that the substrate is not damaged when the difference does not exceed the threshold.

13. A method for detecting breakage of a substrate, the method comprising:
applying an alternating current voltage to a first electrode arranged above the substrate and a second electrode arranged below the substrate;
detecting a current value of an electric current in the substrate; and
determining whether the substrate is damaged based on the detected current value.

14. The method according to claim 13, wherein determining whether the substrate is damaged based on the detected current value comprises:
comparing the detected current value with a current threshold range;
determining that the substrate is damaged when the detected current value is outside the current threshold range; and
determining that the substrate is not damaged when the detected current value is within the current threshold range.

15. The method according to claim 13, wherein determining whether the substrate is damaged based on the detected current value comprises:
calculating a difference between the detected current value and a normal current value of an undamaged substrate which is the same as the substrate;
determining that the substrate is damaged when the difference exceeds a threshold; and
determining that the substrate is not damaged when the difference does not exceed the threshold.

16. The method according to claim 13 further comprising:
transferring the substrate between the first electrode and the second electrode.

17. The method according to claim 15 further comprising:
stopping transferring the substrate after determining that the substrate is damaged.

18. The device according to claim 3, wherein the detector is further configured to:
compare the detected current value with a current threshold range;
determine that the substrate is damaged when the detected current value is outside the current threshold range; and
determine that the substrate is not damaged when the detected current value is within the current threshold range.

19. The device according to claim 3, wherein the detector is further configured to:
calculate a difference between the detected current value and a normal current value of an undamaged substrate which is the same as the substrate;
determine that the substrate is damaged when the difference exceeds a threshold; and
determine that the substrate is not damaged when the difference does not exceed the threshold.

20. The system according to claim 9, wherein a first electrode is arranged in parallel with a second electrode, and wherein a distance between the first electrode and the second electrode is greater than a thickness of the substrate.
